(19) United States
(12) Patent Application Publication
(10) Pub. No.: US 2025/0246943 A1
(43) Pub. Date: Jul. 31, 2025

(54) METHODS FOR OPTIMIZED WIRELESS POWER DELIVERY TO MULTI-ANTENNA RECEIVERS

(71) Applicant: OSSIA INC., Redmond, WA (US)

(72) Inventors: Hatem Zeine, Redmond, WA (US); Caner Guclu, Redmond, WA (US)

(73) Assignee: OSSIA INC., Redmond, WA (US)

(21) Appl. No.: 18/425,907

(22) Filed: Jan. 29, 2024

(51) Int. Cl. H02J 50/80; H02J 50/20; H02J 50/40; H04B 5/79

(52) U.S. Cl. CPC H02J 50/80; H02J 50/20; H02J 50/402; H04B 5/79

(57) ABSTRACT

Described herein are embodiments of apparatuses and methods for optimizing transmissions of wireless power to a wireless power receiver (WPR). In some embodiments, a plurality of subantennas transmit a respective plurality of beacon signals in a beacon duration. Each of the respective plurality of beacon signals is associated with a respective phase set. At least one of the plurality of antennas receives, following the beacon duration, a wireless power transmission transmitted by a wireless power transmitter (WPT). The wireless power transmission uses phase settings based on at least one phase set derived from at least one beacon transmitted in the beacon duration. Direct current (DC) voltage is provided from radio frequency (RF) energy received in the wireless power transmission.

### FIELD OF INVENTION

The embodiments described herein provide improvements in the field of wireless power transmission, specifically in environments including wireless power receivers having multiple antennas.

### BACKGROUND

A wireless power transmitter (WPT) may be able to direct the radiation patterns of wireless power transmissions toward different wireless power receivers (WPRs) in steerable beams by controlling phase settings of its own antenna array. A WPT may determine such phase settings based on beacon signals sent from each WPR. In some environments, WPRs may be deployed with antenna arrays having multiple subantennas, each of which may be capable of emitting a beacon signal. The propagation of beacon signals along paths between the WPT and different subantennas of the array may vary, which may impact the determination of phase settings for wireless power transmissions. Both the amount of radio frequency (RF) power received at each subantenna and the efficiency of the WPR in producing direct current (DC) power from the received RF power may be degraded as a result. Hence, there is a need for methods by which the WPT may direct wireless power transmissions towards optimal paths between the WPT and the subantennas of each WPR. Additionally, in environments where multiple multi-antenna WPRs are deployed, it is possible that different WPRs may have different numbers of subantennas. A need exists for methods by which the WPT may determine optimal paths for wireless power transmission, with consideration of the number of subantennas at the WPR.

### SUMMARY

Described herein are embodiments of apparatuses and methods for optimizing transmissions of wireless power to a wireless power receiver (WPR). In some embodiments, a plurality of antennas belonging to a WPR transmit a respective plurality of beacon signals during a beacon duration. Each of the respective plurality of beacon signals is associated with a respective phase set received at the antenna array of a WPT. At least one of the plurality of subantennas receives, following the beacon duration, a wireless power transmission transmitted by a WPT. The wireless power transmission uses phase settings based on at least one phase set derived from at least one beacon transmitted in the beacon duration. Direct current (DC) voltage is provided from radio frequency (RF) energy received in the wireless power transmission.

In some embodiments, each of the beacon signals carries a signature associated with a respective one of the plurality of WPR antennas.

In some embodiments, the phase settings of the wireless power transmissions are based on a combination of phase sets derived from a plurality of beacons transmitted in previous beacon durations.

In some embodiments, at least one beacon from which at least one phase set is derived is transmitted from at least one of the plurality of subantennas that receives the wireless power transmission.

In some embodiments, another one or more of the plurality of subantennas does not receive the wireless power transmission from the WPT, based on a signal quality of a beacon signal transmitted using the another at least one of the plurality of subantennas.

In some embodiments, at least one of the plurality of subantennas receives the wireless power transmission from the WPT at a power level lower than another subantenna, based on a signal quality of a beacon signal transmitted using the at least one of the plurality of subantennas

In some embodiments the phase settings of the wireless power transmission are further based on an efficiency of the rectifier in providing DC voltage.

In some embodiments, a processor and a plurality of subantennas transmit a respective plurality of beacon signals in a beacon duration. Each of the respective plurality of beacon signals is associated with a respective phase set. At least one of the plurality of subantennas receives, following the beacon duration, a wireless power transmission transmitted by a WPT. The wireless power transmission use phase settings based on at least one phase set derived from at least one beacon transmitted in the beacon duration. A rectifier provides direct current (DC) voltage from radio frequency (RF) energy received in the wireless power transmission.

In some embodiments, the processor and at least one of the plurality of subantennas transmits information indicating a number of beacons to be transmitted, a number of the plurality of subantennas, a multiplexing scheme to be applied to the beacon signals, a time interval length, or a sequence of the beacon signals to be transmitted.

In some embodiments, at least one of the plurality of subantennas receives the wireless power transmission from the WPT at a power level lower than another subantenna, based on a signal quality of a beacon signal transmitted using the at least one of the plurality of subantennas.

In some embodiments, the phase settings of the wireless power transmission are further based on an efficiency of the rectifier in providing DC voltage.

### BRIEF DESCRIPTION OF THE DRAWINGS

FIG. 1 is a system diagram illustrating an example of a wireless power transmission environment.

FIG. 2 is a block diagram illustrating example components of an example embodiment of a WPT.

FIG. 3 is a block diagram illustrating an example embodiment of a WPR.

FIG. 4 is a diagram illustrating an example embodiment of a wireless signal delivery environment.

FIG. 5 is a diagram illustrating an example of a wireless signal delivery environment including a multi-antenna WPR.

FIG. 6 is a flow diagram illustrating an example procedure for receiving wireless power transmissions as may be performed by a multi-antenna WPR.

FIG. 7 is a flow diagram illustrating an example procedure for wireless power transmission as may be performed by a WPT.

FIG. 8 is a flow diagram illustrating an example procedure for receiving wireless power transmissions as may be performed by a multi-antenna WPR.

FIG. 9 is a flow diagram illustrating an example procedure for wireless power transmission as may be performed by a WPT.

FIG. 10 is a diagram illustrating an example scenario in which a WPT may determine to perform wireless power transmission towards a single subantenna or a subset of subantennas based on the presence of an obstruction in a path between one or more subantennas of a WPR and the WPT.

### DETAILED DESCRIPTION OF THE PREFERRED EMBODIMENTS

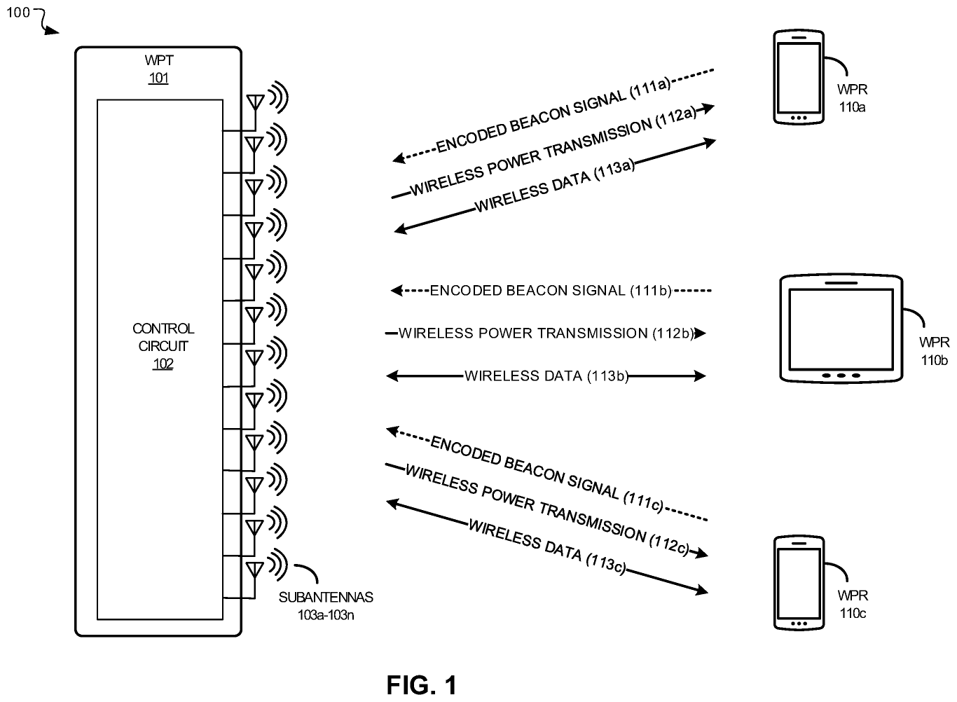

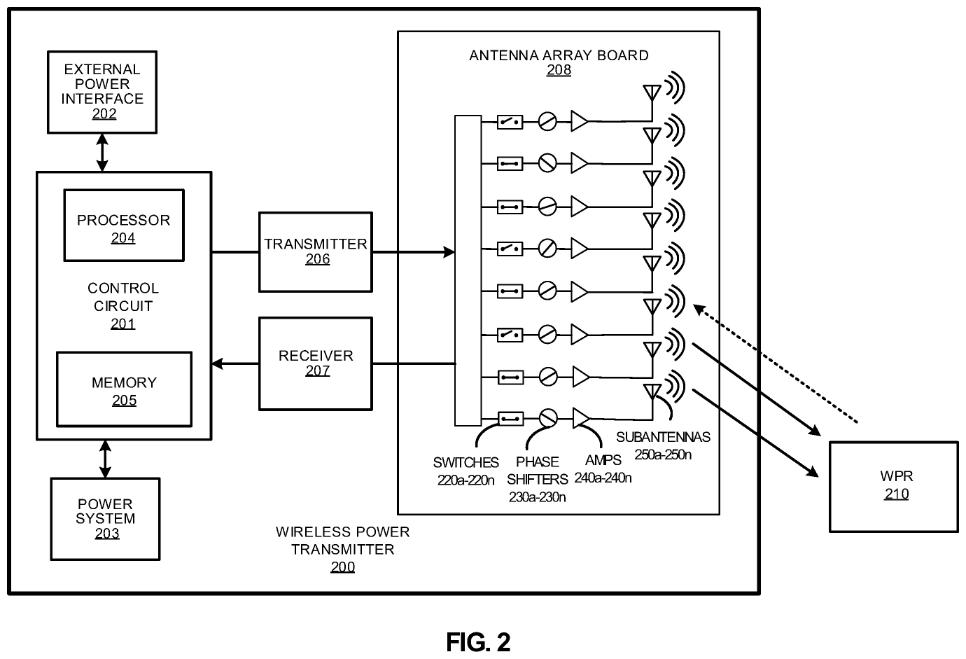

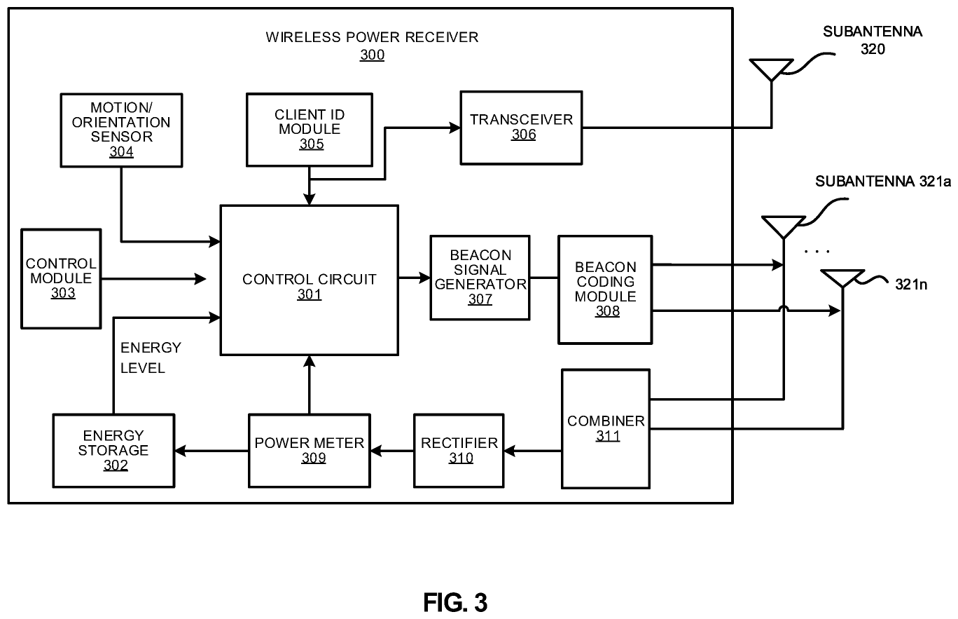

FIG. 1 depicts a system diagram including an example wireless power transmission environment 100 illustrating wireless power delivery from one or more WPTs, such as WPT 101. More specifically, FIG. 1 illustrates power transmission to one or more wireless power receivers (WPRs) 110a-110c. WPT 101 may be configured to receive encoded beacons 111a-111c from WPRs 110a-110c and transmit wireless power 112a-112c to WPRs 110a-110c. Wireless data 113a-113c may also be bidirectionally exchanged between WPT 101 and WPRs 110a-110c. WPRs 110a-110c may be configured to receive and process wireless power 112a-112c and wireless data 113a-113c from one or more WPTs, such as WPT 101. Components of an example WPT 101 are shown and discussed in greater detail below, as well as in FIG. 2. Components of an example WPR 110a-110c are shown and discussed in greater detail with reference to FIG. 3.

WPT 101 may include multiple antennas 103a-103n, e.g., an antenna array including a plurality of subantennas, which may be capable of delivering wireless power 112a-112c to WPRs 110a-110c. Subantennas 103a-103n may further include one or more timing acquisition antennas and one or more communication antennas. In some embodiments, the same subantennas for transmission of wireless power may be used for timing acquisition and wireless data communication. In alternative embodiments, separate subantennas may be used for wireless power, for timing acquisition, and for wireless data communication. In some embodiments, the antennas are adaptively-phased radio frequency (RF) antennas. The WPT 101 may be capable of determining the appropriate phases with which to deliver a coherent power transmission signal to WPRs 110a-110c. Each subantenna of the antenna array including subantennas 103a-103n may be configured to emit a signal, e.g. a continuous wave or pulsed power transmission signal, at a specific phase relative to each other subantenna, such that a coherent sum of the signals transmitted from a collection of the subantennas is focused at a location of a respective WPR 110a-110c. Any number of subantennas may be employed in the reception and transmission of signals depicted in FIG. 1. Multiple antennas, including a portion of subantennas 103a-103n that may include all of subantennas 103a-103n, may be employed in the transmission and/or reception of wireless signals. It is appreciated that use of the term “array” does not necessarily limit the antenna array to any specific array structure. That is, the antenna array does not need to be structured in a specific “array” form or geometry. Furthermore, as used herein the term “array” or “array system” may be used include related and peripheral circuitry for signal generation, reception and transmission, such as radios, digital circuits and modems.

As illustrated in the example of FIG. 1, subantennas 103a-103n may be included in WPT 101 and may be configured to transmit both power and data and to receive data. The antennas 103a-103n may be configured to provide delivery of wireless radio frequency power in a wireless power transmission environment 100, to provide data transmission, and to receive wireless data transmitted by WPRs 110a-110c, including encoded beacon signals 111a-111c. In some embodiments, the data transmission may be carried out using lower power signaling than the wireless radio frequency power transmission. In some embodiments, one or more of the subantennas 103a-103n may be alternatively configured for data communications in lieu of wireless power delivery. In some embodiments, one or more of the power delivery subantennas 103a-103n can alternatively or additionally be configured for data communications in addition to or in lieu of wireless power delivery. The one or more data communication antennas are configured to send data communications to and receive data communications from WPRs 110a-110c.

Each of WPRs 110a-110c may include one or more subantennas (not shown) for transmitting signals to and receiving signals from WPT 101. Likewise, WPT 101 may include an antenna array having one or more subantennas and/or sets of subantennas, each subantenna or set of subantennas being capable of emitting continuous wave or discrete (pulse) signals at specific phases relative to each other antenna or set of antennas. As discussed above, WPTs 101 is capable of determining the appropriate phases for delivering the coherent signals to the subantennas 103a-103n. For example, in some embodiments, delivering coherent signals to a particular WPR can be determined by computing the complex conjugate of a received encoded beacon signal at each subantenna of the array or each subantenna of a portion of the array such that a signal from each subantenna is phased appropriately relative to a signal from other subantennas employed in delivering power or data to the particular WPR that transmitted the beacon signal. The WPT 101 can be configured to emit a signal (e.g., continuous wave (CW) or pulsed transmission signal) from multiple subantennas using multiple waveguides at a specific phase relative to each other.

Although not illustrated, each component of the wireless power transmission environment 100, e.g., WPRs 110a-110c, WPT 101, can include control and synchronization mechanisms, e.g., a data communication synchronization module. WPT 101 can be connected to a power source such as, for example, a power outlet or source connecting the WPTs to a standard or primary alternating current (AC) power supply in a building. Alternatively, or additionally, WPT 101 can be powered by a battery or via other mechanisms, e.g., solar cells, etc.

As shown in the example of FIG. 1, WPRs 110a-110c include mobile phone devices and a wireless tablet. However, WPRs 110a-110c can be any device or system that needs power and is capable of receiving wireless power via one or more integrated WPRs. Although three WPRs 110a-110c are depicted, any number of WPRs may be supported. As discussed herein, a WPR may include one or more integrated power receivers configured to receive and process power from one or more WPTs and provide the power to the WPRs 110a-110c or to internal batteries of the WPRs 110a-110c for operation thereof.

As described herein, each of the WPRs 110a-110c can be any system and/or device, and/or any combination of devices/systems that can establish a connection with another device, a server and/or other systems within the example wireless power transmission environment 100. In some embodiments, the WPRs 110a-110c may each include displays or other output functionalities to present or transmit data to a user and/or input functionalities to receive data from the user. By way of example, WPR 110a can be, but is not limited to, a video game controller, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. By way of example and not limitation, WPR 110a can also be any wearable device such as watches, necklaces, rings or even devices embedded on or within the customer. Other examples of WPR 110a include, but are not limited to, a safety sensor, e.g. a fire or carbon monoxide sensor, price displays, an electric toothbrush, an electronic door lock/handle, an electric light switch controller, an electric shaver, an electronic shelf label (ESL), etc.

Although not illustrated in the example of FIG. 1, the WPT 101 and the WPRs 110a-110c can each include a data communication module for communication via a data channel. Alternatively, or additionally, the WPRs 110a-110c can direct antennas to communicate with WPT 101 via existing data communications modules. In some embodiments, the WPT 101 can have an embedded Wi-Fi hub for data communications via one or more antennas or transceivers. In some embodiments, the antennas 103a-103n can communicate via Bluetooth™, Wi-Fi™, ZigBee™, etc. The WPRs 110a-110c may also include an embedded Bluetooth™, Wi-Fi™, ZigBee™, etc. transceiver for communicating with the WPT 101. Other data communication protocols are also possible. In some embodiments the beacon signal, which is primarily referred to herein as a continuous waveform, can alternatively or additionally take the form of a modulated signal and/or a discrete/pulsed signal.

WPT 101 may also include control circuit 102. Control circuit 102 may be configured to provide control and intelligence to the WPT 101 components. Control circuit 102 may comprise one or more processors, memory units, etc., and may direct and control the various data and power communications. Control circuit 102 may direct data communications on a data carrier frequency that may be the same or different than the frequency via which wireless power is delivered. Likewise, control circuit 102 can direct wireless transmission system 100 to communicate with WPRs 110a-110c as discussed herein. The data communications can be, by way of example and not limitation, Bluetooth™, Wi-Fi™, ZigBee™, etc. Other communication protocols are possible.

It is appreciated that the use of the term “WPT” does not necessarily limit the WPT to any specific structure. That is, the WPT does not need to be structured in a specific form or geometry. Furthermore, as used herein the term “transmission system” or “WPT” may be used to include related and peripheral circuitry for signal generation, reception and transmission, such as radios, digital circuits and modems.

FIG. 2 is a block diagram illustrating example components of a WPT 200 in accordance with the embodiments described herein. As illustrated in the example of FIG. 2, the WPT 200 may include a control circuit 201, external power interface 202, and power system 203. Control circuit 201 may include processor 204, for example a base band processor, and memory 205. Additionally, although only one antenna array board 208 and one transmitter 206 are depicted in FIG. 2, WPT 200 may include one or more transmitters 206 coupled to one or more antenna array boards 208 and transmit signals to the one or more antenna array boards 208. Although only one receiver is depicted in FIG. 2, one or more receivers 207 may be coupled to the one or more antenna array boards 208 and may receive signals from the one or more antennas 250a-250n of the one or more antenna array boards 208. Each antenna array board 208 includes switches 220a-220n, phase shifters 230a-230n, power amplifiers 240a-240n, and subantennas 250a-250n. Although each switch, phase shifter, power amplifier, and subantenna is depicted in a one-to-one relationship, this should not be construed as limiting. Additionally or alternatively, any number of switches, phase shifters, power amplifiers, and antennas may be coupled. Some or all of the components of the WPT 200 can be omitted, combined, or sub-divided in some embodiments. Furthermore, the setting of the switches 220a-220n and phase shifters 230a-230n should not be construed as limiting. Any of the switches 220a-220n, phase shifters 230a-230n, and/or power amplifiers 240a-240n, or any combination thereof, may be individually controlled or controlled in groups. The signals transmitted and received by the one or more antenna array boards 208 may be wireless power signals, wireless data signals, or both.

Control circuit 201 is configured to provide control and intelligence to the array components including the switches 220a-220n, phase shifters 230a-230n, power amplifiers 240a-240n, and subantennas 250a-250n. Control circuit 201 may direct and control the various data and power communications. Transmitter 206 can generate a signal comprising power or data communications on a carrier frequency. The signal can comply with a standardized format such as Bluetooth™, Wi-Fi™, ZigBee™, etc., including combinations or variations thereof. Additionally or alternatively, the signal can be a proprietary format that does not use Bluetooth™, Wi-Fi™, ZigBee™, and the like, and utilizes the same switches 220a-220n, phase shifters 230a-230n, power amplifiers 240a-240n, and antenna arrays 250a-250n to transmit wireless data as are used to transmit wireless power. Such a configuration may save on hardware complexity and conserve power by operating independently of the constraints imposed by compliance with the aforementioned standardized formats. In some embodiments, control circuit 201 can also determine a transmission configuration comprising a directional transmission through the control of the switches 220a-220n, phase shifters 230a-230n, and amplifiers 240a-240n based on an encoded beacon signal received from a WPR 210.

The external power interface 202 is configured to receive external power and provide the power to various components. In some embodiments, the external power interface 202 may be configured to receive, for example, a standard external 24 Volt power supply. In other embodiments, the external power interface 202 can be, for example, 120/240 Volt AC mains to an embedded DC power supply which may source, for example, Dec. 24, 1948 Volt DC to provide the power to various components. Alternatively, the external power interface could be a DC supply which may source, for example, Dec. 24, 1948 Volts DC. Alternative configurations including other voltages are also possible.

Switches 220a-220n may be activated to transmit power and/or data and receive encoded beacon signals based on the state of the switches 220a-220n. In one example, switches 220a-220n may be activated, e.g. closed, or deactivated, e.g. open, for power transmission, data transmission, and/or encoded beacon reception. Additional components are also possible. For example, in some embodiments phase-shifters 230a-230n may be included to change the phase of a signal when transmitting power or data to a WPR 210. Phase shifter 230a-230n may transmit a power or data signal to WPR 210 based on a phase of a complex conjugate of the encoded beaconing signal from WPR 210. The phase-shift may also be determined by processing the encoded beaconing signal received from WPR 210 and identifying WPR 210. WPT 200 may then determine a phase-shift associated with WPR 210 to transmit the power signal. In an example embodiment, data transmitted from the WPT 200 may be in the form of communication beacons which may be used to synchronize clocks with WPR 210. This synchronization may improve the reliability of beacon phase detection.

In operation, control circuit 201, which may control the WPT 200, may receive power from a power source over external power interface 202 and may be activated. Control circuit 201 may identify an available WPR 210 within range of the WPT 200 by receiving an encoded beacon signal initiated by the WPR 210 via at least a portion of subantennas 250a-250n. When the WPR 210 is identified based on the encoded beacon signal, a set of antenna elements on the WPT may power on, enumerate, and calibrate for wireless power and/or data transmission. At this point, control circuit 201 may also be able to simultaneously receive additional encoded beacon signals from other WPRs via at least a portion of antennas 250a-250n.

One of skill in the art may appreciate that, once the transmission configuration has been generated and instructions have been received from control circuit 201, transmitter 206 may generate and transfer one or more power and/or data signal waves to one or more antenna boards 208. Based on the instruction and generated signals, at least a portion of power switches 220a-220n may be opened or closed and at least a portion of phase shifters 230a-230n may be set to the appropriate phase associated with the transmission configuration. The power and/or data signal may then be amplified by at least a portion of power amplifiers 240a-240n and transmitted at an angle directed toward a location of WPR 210. As discussed herein, at least a portion of antennas 250a-250n may be simultaneously receiving encoded beacon signals from additional WPRs 210.

As described above, a WPT 200 may include one or more antenna array boards 208. In one embodiment, each antenna array board 208 may be configured to communicate with a single WPR 210, so that a different antenna array board 208 of a plurality of antenna array boards 208 communicates with a different WPR 210 of a plurality of WPRs 210. Such an implementation may remove a reliance on a communication method, such as a low-rate personal area network (LR-WPAN), IEEE 802.15.4, or Bluetooth Low Energy (BLE) connection to synchronize with a WPR 210. A WPT 200 may receive a same message from a WPR 210 via different subantennas of subantennas 250a-250n. The WPT 200 may use the replication of the same message across the different antennas to establish a more reliable communication link. In such a scenario, a beacon power may be lowered since the lower power can be compensated by the improved reliability owed to the replicated received signals. In some embodiments, it may also be possible to dedicate certain antennas or groups of subantennas for data communication and dedicate other antennas or groups of antennas for power delivery. For example, an example WPT 200 may dedicate 8 or 16 subantennas of subantennas 250a-250n to data communication at a lower power level than some number of remaining antennas that may be dedicated to power delivery at a relatively higher power level than the data communication.

FIG. 3 is a block diagram illustrating an example WPR 300 in accordance with embodiments described herein. As shown in the example of FIG. 3, WPR 300 may include control circuit 301, energy storage 302, a control module 303, for example an Internet of Things (IoT) control module, transceiver 306 and associated one or more antennas 320, power meter 309, rectifier 310, and a combiner 311. The combiner 311 may be connected to one or more subantennas 321a-321n of an antenna array board. In some embodiments as shown in FIG. 3, the WPR 300 may include a beacon signal generator 307 and beacon coding module 308. The beacon signal generator 307 and coding module 308 may be connected to some or all of the subantennas 321a-321n. The energy storage 302 may be, for example, a battery, a capacitor, or any other suitable energy storage device. Although not depicted, the WPR 300 may include an energy harvesting circuit that may enable the WPR 300 to operate with a capacitor for short term energy storage instead of or in addition to using a battery. Some or all of the depicted components in FIG. 3 can be omitted, combined, or sub-divided in some embodiments. Some or all of the components depicted in FIG. 3 may be incorporated in a single integrated chip (IC). It should be noted that although the WPT 200 may use full-duplexing, WPR 300 may additionally or alternatively use half-duplexing. A received and/or transmitted data rate may be, for example, 20 Mbps. However, higher or lower data rates may be implemented to achieve other design goals. The WPR 300 may transmit acknowledgement (ACK) messages back to a WPT, such as a WPT 200 depicted in FIG. 2. Although not depicted, a local CPU may be incorporated into WPR 300. For example, the local CPU may be included in the control circuit 301.

The combiner 311 may receive and combine the received power and/or data transmission signals received via one or more subantennas 321a-321n. The combiner can be any combiner or divider circuit that is configured to achieve isolation between output ports while maintaining a matched condition. For example, the combiner 311 can be a Wilkinson Power Divider circuit. The combiner 311 may be used to combine two or more RF signals while maintaining a characteristic impedance, for example, 50 ohms. The combiner 311 may be a resistive-type combiner, which uses resistors, or a hybrid-type combiner, which uses transformers. The rectifier 310 may receive the combined power transmission signal from the combiner 311, if present, which may be fed through the power meter 309 to the energy storage 302 for charging. In some embodiments not shown in FIG. 3, each antenna's power path can have its own rectifier 310 and the DC power out of the rectifiers is combined prior to feeding the power meter 309. The power meter 309 may measure the received power signal strength and may provide the control circuit 301 with this measurement.

Energy storage 302 may include protection circuitry and/or monitoring functions. Additionally, the energy storage 302 may include one or more features, including, but not limited to, current limiting, temperature protection, over/under voltage alerts and protection, and capacity monitoring, for example coulomb monitoring. The control circuit 301 may receive the energy level from the energy storage 302 itself. The control circuit 301 may also transmit/receive via the transceiver 306 a data signal on a data carrier frequency, such as the base signal clock for clock synchronization. The beacon signal generator 307 may generate the beacon signal and the beacon signal may then be transmitted using one or more of the subantennas 321a-321n.

In some embodiments as depicted in FIG. 3, a beacon coding module 308 may orthogonally encode beacon signals to be transmitted by some or all of the subantennas 320, or 321a-321n. This may enable code-based multiplexing such that the coded beacon signals that are transmitted in the multiplexed beacon may be discerned.

It may be noted that, although the energy storage 302 is shown as charged by, and providing power to, WPR 300, the receiver may also receive its power directly from the rectifier 310. This may be in addition to the rectifier 310 providing charging current to the energy storage 302, or in lieu of providing charging. Also, it may be noted that the use of multiple subantennas 320 and 321a-321n is one example of implementation, however the structure may be reduced to fewer subantennas, such as one shared subantenna.

In some embodiments, the control circuit 301 and/or the control module 303 can communicate with and/or otherwise derive device information from WPR 300. The device information can include, but is not limited to, information about the capabilities of the WPR 300, usage information of the WPR 300, power levels of the energy storage 302 of the WPR 300, and/or information obtained or inferred by the WPR 300. In some embodiments, a client identifier (ID) module 305 stores a client ID that can uniquely identify the WPR 300 in a wireless power delivery environment. For example, the ID can be transmitted to one or more WPTs in the encoded beacon signal. In some embodiments, WPRs may also be able to receive and identify other WPRs in a wireless power delivery environment based on the client ID.

A motion/orientation sensor 304 can detect motion and/or orientation and may signal the control circuit 301 to act accordingly. For example, a device receiving power may integrate motion detection mechanisms such as accelerometers or equivalent mechanisms to detect motion. Once the device detects that it is in motion, it may be assumed that it is being handled by a user, and may trigger a signal to the antenna array of the WPT to either stop transmitting power and/or data, or to initiate wireless power and/or data transmission from the WPT. The WPR may use the encoded beacon or other signaling to communicate with the WPT. In some embodiments, when a WPR 300 is used in a moving environment like a car, train or plane, the power might only be transmitted intermittently or at a reduced level unless the WPR 300 is critically low on power, when the WPT is not located in the vehicle.

Additionally or alternatively, a WPR 300 may include an orientation sensor which may sense a particular orientation of the WPR 300. An orientation of the WPR 300 may affect how it receives wireless power from a WPT. Thus, an orientation may be used to determine a best WPT with which to pair. Motion/orientation sensor 304 may include only a motion sensor, only an orientation sensor, or may integrate both. Alternatively, two or more separate sensors may be used. Additionally or alternatively, a WPR 300 may detect a direction of signals received via its subantennas from one or more WPTs to determine its orientation relative to the one or more WPTs. Thus, in some embodiments, a WPR 300 may be able to detect a relative orientation without a need for an orientation sensor.

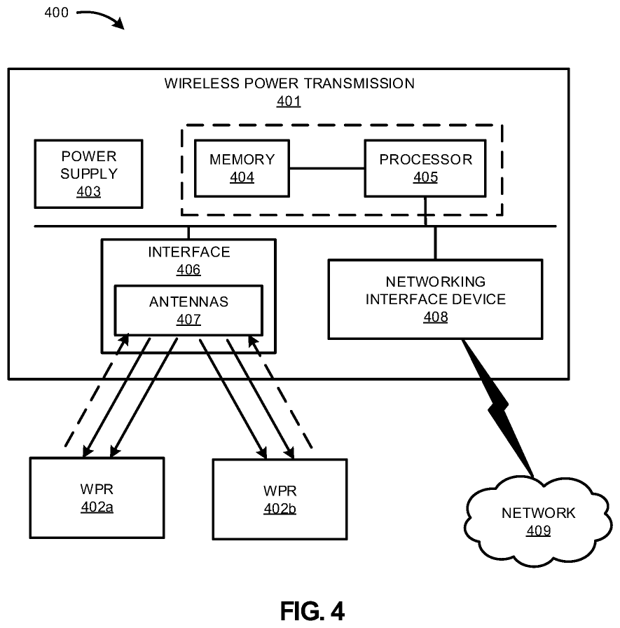

FIG. 4 is a diagram illustrating an example wireless signal delivery environment 400 in accordance with embodiments described herein. The wireless signal delivery environment 400 includes WPT 401, a user operating WPRs 402a and 402b, and wireless network 409. Although two WPRs are depicted in FIG. 4, any number of WPRs may be supported. WPT 401 as depicted in FIG. 4 can alternatively be implemented in accordance with WPT 101 as depicted in FIG. 1. Alternative configurations are also possible. Likewise, WPRs 402a and 402b as depicted in FIG. 4 can be implemented in accordance with WPRs 110a-110c of FIG. 1, or can be implemented in accordance with WPR 300 as depicted in FIG. 3, although alternative configurations are also possible.

WPT 401 may include a power supply 403, memory 404, processor 405, interface 406, one or more antennas 407, and a networking interface device 408. Some or all of the components of the WPT 401 can be omitted, combined, or sub-divided in some embodiments. The one or more antennas 407 may each include one or more subantennas. The networking interface device may communicate wired or wirelessly with a network 409 to exchange information that may ultimately be communicated to or from WPRs 402a and 402b. The one or more antennas 407 may also include one or more receivers, transmitters, and/or transceivers. The one or more antennas 407 may have a radiation and reception pattern directed in a space proximate to WPR 402a, WPR 402b, or both, as appropriate. WPT 401 may transmit a wireless power signal, wireless data signal, or both over at least a portion of antennas 407 to WPRs 402a and 402b. As discussed herein, WPT 401 may transmit the wireless power signal, wireless data signal, or both at an angle in the direction of WPRs 402a and 402b such that the strength of the respectively received wireless signal by WPRs 402a and 402b depends on the accuracy of the directivity of the corresponding directed transmission beams from at least a portion of antennas 407.

A fundamental property of antennas is that the receiving pattern of an antenna when used for receiving is directly related to the far-field radiation pattern of the antenna when used for transmitting. This is a consequence of the reciprocity theorem in electromagnetics. The radiation pattern can be any number of shapes and strengths depending on the directivity of the beam created by the waveform characteristics and the types of antennas used in the antenna design of the antennas 407. The types of antennas 407 may include, for example, horn antennas, simple vertical antenna, etc. The antenna radiation pattern can comprise any number of different antenna radiation patterns, including various directive patterns, in a wireless signal delivery environment 400. By way of example and without limitation, wireless power transmit characteristics can include phase settings for each antenna and/or transceiver, transmission power settings for each antenna and/or transceiver, or any combination of groups of antennas and transceivers, etc.

As described herein, the WPT 401 may determine wireless communication transmit characteristics such that, once the antennas and/or transceivers are configured, the multiple antennas and/or transceivers are operable to transmit a wireless power signal and/or wireless data signal that matches the WPR radiation pattern in the space proximate to the WPR. Advantageously, as discussed herein, the wireless signal, including a power signal, data signal, or both, may be adjusted to more accurately direct the beam of the wireless signal toward a location of a respective WPR, such as WPRs 402a and 402b as depicted in FIG. 4.

The directivity of the radiation pattern shown in the example of FIG. 4 is illustrated for simplicity. It is appreciated that any number of paths can be utilized for transmitting the wireless signal to WPRs 402a and 402b depending on, among other factors, reflective and absorptive objects in the wireless communication delivery environment. FIG. 4 depicts direct signal paths, however other signal paths, including multi-path signals, that are not direct are also possible.

The positioning and repositioning of WPRs 402a and 402b in the wireless communication delivery environment may be tracked by WPT 401 using a three-dimensional angle of incidence of an RF signal at any polarity paired with a distance that may be determined by using an RF signal strength or any other method. As discussed herein, an array of antennas 407 capable of measuring phase may be used to detect a wave-front angle of incidence. A respective angle of direction toward WPRs 402a and 402b may be determined based on respective distance to WPRs 402a and 402b and on respective power calculations. Alternatively, or additionally, the respective angle of direction to WPRs 402a and 402b can be determined from multiple antenna array segments 407.

In some embodiments, the degree of accuracy in determining the respective angle of direction toward WPRs 402a and 402b may depend on the size and number of antennas 407, number of phase steps, method of phase detection, accuracy of distance measurement method, RF noise level in environment, etc. In some embodiments, users may be asked to agree to a privacy policy defined by an administrator for tracking their location and movements within the environment. Furthermore, in some embodiments, the system can use the location information to modify the flow of information between devices and optimize the environment. Additionally, the system can track historical wireless device location information and develop movement pattern information, profile information, and preference information.

As is described substantially in paragraphs above, a WPR may include multiple antennas or subantennas. The transmission of encoded beacon signals and the reception of power transmissions by multi-antenna WPRs may pose several challenges. When a WPR transmits encoded beacon signals to a WPT to synchronize timing between the WPT and WPR and to enable the WPT to observe and/or determine parameters for power transmissions (e.g., phase set, power budget, and beamforming characteristics, etc.) to the WPR, it may do so by, for example, by transmitting encoded beacons from a single subantenna (e.g., a “central” antenna element) or by transmitting encoded beacons from all subantennas.

Upon receiving an encoded beacon signal, a WPT may demodulate the signal to obtain phase values, such as in-phase and quadrature (I&Q) components of the signal. The WPT may also obtain other information about the beacon signal, such as a signal quality or signal strength metric (e.g., a received signal strength indicator (RSSI), or a power level (e.g., expressed in decibel-milliwatts (dBM)). Using the derived phase value, signal quality, and/or signal strength, the WPT may be capable of determining optimized parameters for power transmissions over a reciprocal path toward the WPR's antenna.

When a beacon is transmitted from a single one of the WPR's subantennas (e.g., a central antenna element), the parameters determined by the WPT for power transmission over a reciprocal path may be sub-optimal because the beacon signal may not reflect characteristics of a multi-antenna array that prove advantageous for power reception. For example, a multi-antenna WPR may enable harvesting of power across more than one subantenna (i.e., all or a subset of antennas of an array), owing to an increased effective antenna aperture or receiving cross section, which in turn can provide for greater received power in a given time frame.

On the other hand, when beacons are emitted from all of the WPR's subantennas, each beacon is carried by a “beam” that may or may not be directed towards the best path between the WPR and WPT. When the WPT processes the beacons, sub-optimal phase settings determined for subsequent power transmissions as a result of one or more of the beacons having poor signal quality may also result in degraded power delivery.

Systems and apparatuses, and methods and procedures performed by a multi-antenna WPR and corresponding methods and procedures performed by a WPT to address at least the above-noted challenges are proposed herein.

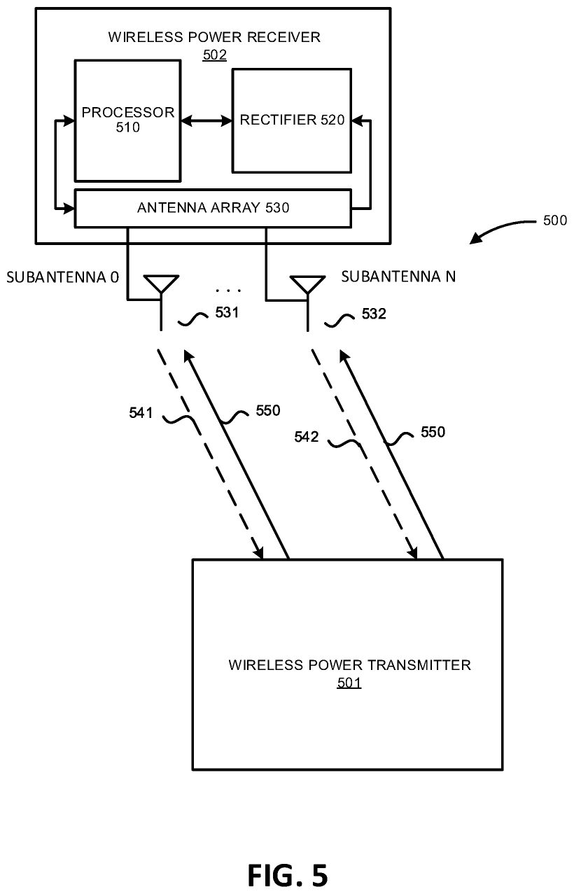

FIG. 5 is a diagram illustrating an example of a wireless signal delivery environment including a multi-antenna WPR, consistent with embodiments as may be described herein. The wireless signal delivery environment 500, as depicted, may include one WPT 501 and one WPR 502, though it should be appreciated that the environment 500 may include more than one WPT and/or more than one WPR. WPT 501 as depicted in FIG. 5 may be implemented in accordance with WPT 101 as depicted in FIG. 1. Alternative configurations are also possible. Likewise, the WPR 502 as depicted in FIG. 5 can be implemented in accordance with any of WPRs 110a-110c of FIG. 1, or can be implemented in accordance with WPR 300 as depicted in FIG. 3, although alternative configurations are also possible.

As shown in FIG. 5, WPR 502 may at least include a processor 510, a rectifier 520, and an antenna array 530. The antenna array 530 as shown in FIG. 5 includes two subantennas 531 and 532, though it should be appreciated that in embodiments not directly shown, the antenna array 530 may conceivably include a greater number of subantennas.

As shown in FIG. 5, the WPR 502 transmits a first beacon signal 541 toward the WPT 501 using a first subantenna 531. The WPT 501 receives the beacon signal 541 and obtains and stores phase set data associated with the subantenna 531. The stored phase set data may be earmarked based on the obtained signature of the subantenna 531 located at the WPR 502 (e.g., device 0, antenna sub-channel 0). The stored phase set information may include, for example, in-phase and quadrature (I&Q) component data of the received beacon signal 541.

The WPR 502 transmits a second beacon signal 542 toward the WPT 501 using a second subantenna 532. The second beacon signal 542 has a signature different from the signature of the first beacon signal 541. The WPT 501 receives the beacon signal 542 and obtains and stores phase set data associated with the subantenna 532. The phase set data may be earmarked in association with the obtained signature of the subantenna 532 located at the WPR 502 (e.g., tagged as device 0, antenna channel 1).

The WPT 501 sends wireless power 550 toward the WPR 502 using a reciprocal phase set that is based on the obtained phase set data corresponding to the subantennas 531 and 532. In some cases, as shown in FIG. 5, the WPT 501 may perform wireless power transmission 550 toward all subantennas of the WPR 502, e.g., by algorithmically combining the phase set data earmarked in association with all subantennas of the WPR 502.

In one set of approaches as may be implemented in the environment 500 depicted in FIG. 5, beacon signals 541 and 542 may be transmitted from each subantenna of a multi-antenna WPR 502 sequentially in different beacon durations. Once the WPT 501 receives the first beacon, it may determine a phase set (i.e., I&Q component values) and store the information. The WPT 501 may then send power by processing the stored I&Q values to determine phase settings for wireless power transmission 550.

The WPR 502 may transmit a second beacon signal from another antenna in a subsequent beacon duration. The WPT 501 may store the corresponding I&Q values as another data set of the same receiver. The data sets may be earmarked by indices of the WPR's 502 corresponding subantennas. Following the second beacon duration, the WPT may again send a wireless power transmission, determining phase settings by considering the stored data sets for each of the previously received beacons. The WPR 502 may continue transmitting beacons for each subantenna, and the WPT 501 may continue capturing phase sets of each subantenna in order to improve the retrodirective pattern used for sending wireless power transmissions.

The WPT 501 may receive the repeated beacon signals and replace the determined I&Q values for each subantenna beacon with an updated set of I&Q values, before continuing to deliver power using an updated phase setting for power transmission that is derived from the updated I&Q values.

Such methods may be advantageous in that they may not tax the complexity of the transmitter. They may, however, result in a lower effective beacon rate, since the most optimal phase setting for power transmission may generally only be determined once all the sets of beacons have been transmitted, and such a scheme may entail a low beacon transmission rate.

Phase setting for power transmission by the WPT may be determined, in some examples, by selecting one of the received beacons, e.g., having a highest signal quality and processing its corresponding I&Q values to derive a reciprocal phase setting.

A phase set for power transmission by the WPT may be determined, in some examples, by combining the I&Q values derived from beacon signals captured from different WPR antennas. For example, a WPT may algorithmically combine phase set data of all (or a subset) of the signals in vector space to determine a phase set for power transmission. In some cases, a weighting coefficient may be applied to I&Q values for each path such that subantennas having the lowest signal quality beacons may receive the least amount of power, so as to optimize the power delivery to subantennas that have higher signal quality beacons and are most capable of efficiently harvesting such power.

In approaches in which one beacon signal is transmitted from each subantenna, as introduced generally in paragraphs above, each subantenna of a WPR may act as a sub-receiver. A signature may be assigned to each antenna port (also referred to herein as an “antenna sub-channel,” or simply “sub-channel”) at each WPR, as opposed to existing approaches in which only one signature is assigned to each WPR. A signature may be indicated (e.g., in a preamble) or encoded in the beacon signal.

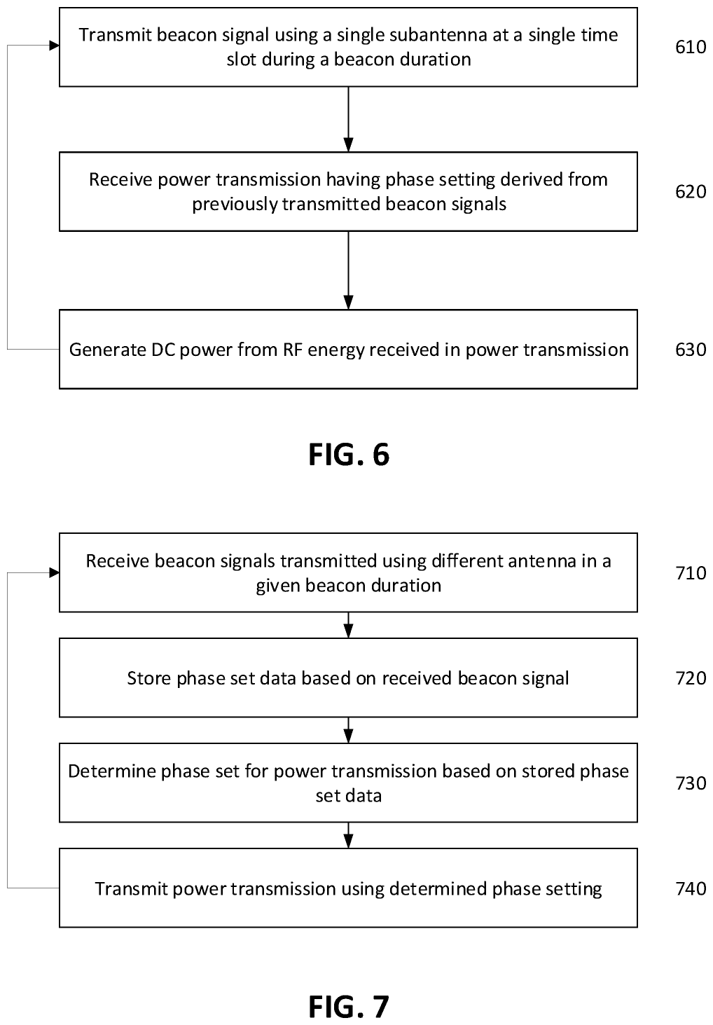

FIG. 6 is a flow diagram illustrating an example procedure for receiving wireless power transmissions as may be performed by a multi-antenna WPR. As shown at step 610, a WPR may transmit a single beacon signal from a single subantenna of an antenna array. The transmission of a beacon signal from a single subantenna may take place during a single time slot within a beacon duration. The beacon signal may be encoded with a signature that identifies the WPR and/or subantenna channel over which the beacon signals is transmitted. At step 620, the WPR may receive a power transmission from a WPT, which may use a retrodirective pattern that may be optimized, for example, based on the phase of previously transmitted beacon signals, including the beacon signal transmitted in step 610. At step 630, the WPR may generate direct current (DC) power from the RF power received at the subantenna. The RF power received at each subantenna may first be combined before rectification, or alternatively, the RF power received at each subantenna may be rectified separately. The WPR may repeat steps 610-630, transmitting a single beacon signal from a next antenna array in a next beacon duration, receiving a next power transmission having a retrodirective pattern optimized based on the phases of both of the previously transmitted beacon signals, and generating DC power from the combined energy harvested by subantennas of the array. Once the WPR has transmitted beacon signals using a complete set of subantennas, the WPT may repeat the entire procedure starting again with the first subantenna.

FIG. 7 is a flow diagram illustrating an example procedure for wireless power transmission as may be performed by a WPT. As shown at step 710, in a first beacon duration, the WPT may receive beacon signals from a different subantennas of the multi-antenna WPR. Each beacon signal may be received in a single time slot during a beacon duration. At step 720, the WTPS may receive a phase set from each of the one or more received beacon signal and store an I&Q set associated with each subantenna of the WPR that transmitted the received beacon signal. At step 730, the WPT may determine a retrodirective pattern that is optimized based on the stored I&Q values derived from the first beacon signal. For example, the WPT may determine a phase set for power transmission based on the stored phase set data. The determined phase set for power transmission may be derived by algorithmically merging the previous phase sets. At step 730, the WPT may transmit a wireless power transmission to the WPR using the determined retrodirective pattern. At step 740, WPT may repeat steps 710-730, receiving beacon signals from all of the subantennas of the WPR, storing phase set data from the received beacon signals to determine an optimal phase setting for wireless power transmissions to the WPR. At step 750, once the WPT has received beacon signals from a complete set of subantennas of the WPR, the WPT may repeat steps 710-740 starting by receiving another beacon from the first subantenna of the WPR, and replacing the stored I&Q values for each antenna after each successive beacon duration.

Another set of approaches may provide for the transmission of one beacon signal from multiple subantennas in a given beacon duration. In such cases, instead of transmitting one beacon signal from each antenna in different beacon durations, the WPR may transmit the same beacon signal for a specific slot from each antenna, in sequence, during the same beacon duration. The WPT may capture the phases of each antenna at the WPR based on each respective beacon signal. Once the phases are captured for all WPR antennas, the WPT may derive I&Q values for each antenna of the WPR and determine a corresponding phase set for power transmissions to the WPR.

In some cases as described above, the phase set for power transmission by the WPT may be determined, for example, by combining the I&Q values derived from beacon signals captured from different WPR antennas (e.g., by adding the I&Q values in vector space). In other cases, the phase set for power transmission by the WPT may be determined based a received beacon having a highest signal quality. Using these approaches, it may be possible to achieve greater power delivery than by approaches in which a different beacon is transmitted from each subantenna.

In embodiments providing for transmission of one beacon signal from multiple subantennas, a WPR and a WPT may negotiate and agree upon on a scheme for orthogonal transmission of beacons from different sources (i.e., antennas) within a given beacon window. Such schemes may be, for example, time domain multiplexing (TDM) schemes or code domain multiplexing (CDM) schemes.

In an example of a TDM scheme, a WPR that has two antenna sub-channels and is configured to transmit beacon signals within a 100 microsecond (μs) beacon window may use, for example, the first 50 μs of the window for a beacon signal transmission on antenna subchannel 0. The remaining 50 μs of the window may be used for a beacon signal transmission on antenna subchannel 1. It should be appreciated that a WPR that has more than two subantennas, or has a longer or shorter beacon duration, may implement a different switching scheme. Such TDM schemes may result in a slight increase in complexity of the WPR.

In a CDM scheme, the WPR that has multiple antenna sub-channels may send beacon signals over both antenna sub-channels simultaneously (or near simultaneously). The beacon signals may be coded in a manner such that the beacon signals can be separated. For example, the beacon signals may be orthogonally coded, such as by applying a Walsh function. Such CDM schemes, may also result in a slight increase in complexity of the WPR.

A preamble may be included in front of a beacon signal in order to provide parameters necessary to receive the beacon signals. For example, the preamble may include information indicating a sequence of the beacon transmissions, a length of the beacon duration, a number of beacon signals to be transmitted during the beacon duration, or a number of antennas at the WPR that may transmit beacon signals. A preamble may include information about a multiplexing scheme to be used by the WPR. For example, the preamble may indicate that a TDM or CDM scheme is to be used. The preamble may be included, for example, in every beacon signal that is transmitted by the WPR or periodically in a subset of beacon signals or in a single beacon signal that is transmitted within a beacon duration.

In some embodiments, such as those where a WPT powers WPRs having different numbers of subantennas, it may be advantageous that the WPT is aware of how many different antennas are used at a WPR. In addition, it may be advantageous that the WPT is aware of the type of orthogonal beacon transmission scheme that will be used by a WPR so that it can expect the correct beacon format and duration. Such information may be provided by the WPR to the WPT, for example, via a separate communications channel between the WPR and the WPT, or it may be front-loaded in a preamble. Additionally, it may be preferable to include such information in only some beacons in order to reduce the complexity of the WPR as well as signaling overhead.

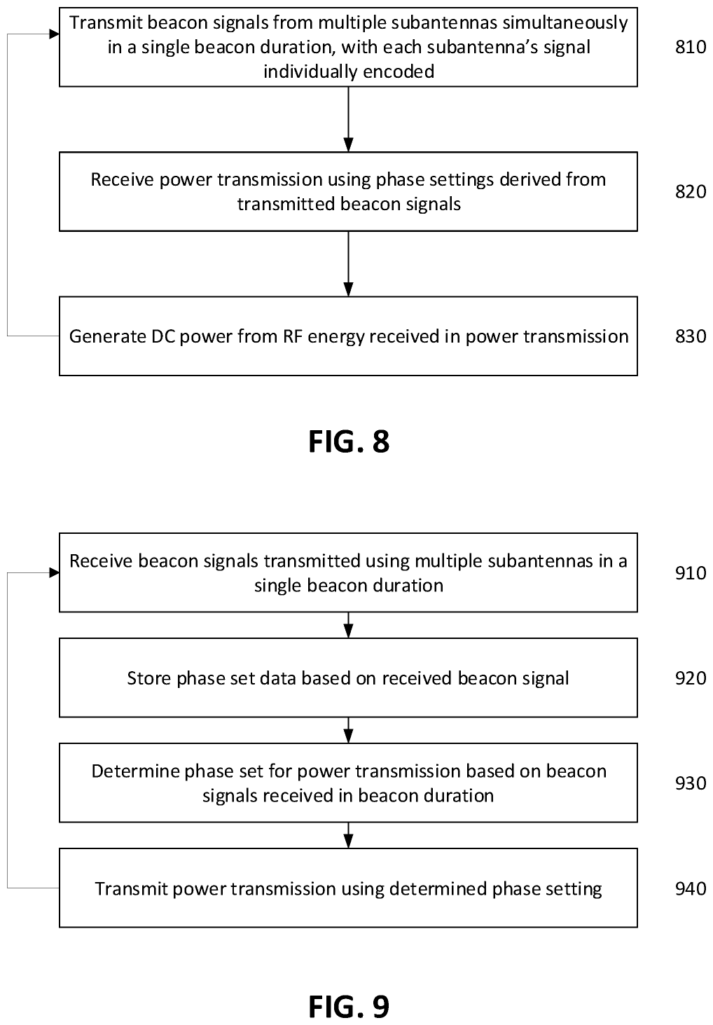

FIG. 8 is a flow diagram illustrating an example procedure for receiving wireless power transmissions as may be performed by a multi-antenna WPR. As shown at step 810, a WPR may transmit beacon signals from multiple subantennas, and at least one of the beacon signals may include a preamble that indicates, for example, a number of beacon signals that the WPT should expect to receive. The preamble may further include an indication of a multiplexing scheme to be used to transmit the beacon signals. The beacon signals may be multiplexed using the indicated scheme, for example, according to one or more methods (e.g., CDM or TDM, in other embodiments not shown) as described herein. For example, as is described in FIG. 8, the beacon signals may be transmitted simultaneously during a single beacon duration. In a CDM scenario, each subantenna's signal may individually encoded. At step 820, the WPR may receive a power transmission from a WPT, which may use a retrodirective pattern that is optimized based on the phases of some or all of the multiplexed beacon signals transmitted in step 810. At step 830, the WPR may combine RF energy received at the antennas in the power transmission from the WPT, if applicable, and generate direct current (DC) power.

FIG. 9 is a flow diagram illustrating an example procedure for wireless power transmission as may be performed by a WPT. As shown at step 910, the WPT may receive beacon signals from multiple subantennas of a WPR. The beacon signals may be received, for example, during the same beacon duration. At least one of the beacon signals may include a preamble that indicates, for example, a number of beacon signals that the WPT should expect to receive. The preamble may further include an indication of a multiplexing scheme to be used to transmit the beacon signals. At step 920, the WTPS may determine a phase set from the received beacon signals and store I&Q values associated with the antennas of the WPR that transmitted the beacon signal. At step 930, the WPT may determine a retrodirective pattern (i.e., phase setting) that is optimized based on the stored I&Q values derived from the received beacon signal. At step 940, the WPT may transmit a wireless power transmission to the WPR using the determined phase settings.

In some embodiments, it may be possible to use only a subset of the subantennas located within an antenna array of the WPR to transmit beacon signals, which may reduce the time required for a WPT to receive and process the beacon signals and optimize the power delivery. For example, in a TDM scheme, if an antenna array includes a large number of antenna elements, the time required to transmit beacons from all subantennas of the array may be too great. As an optimal system for wireless power transmission may seek to minimize the amount of time spent transmitting and listening for beacon signals and instead seek to maximize the amount of time available for delivering RF power, using only a subset of subantennas to transmit beacon signals may be advantageous.

Further detail as to the phase set determination for power transmission, including methods for weighting of I&Q values associated with received beacon signals and/or narrowing the I&Q values upon which the phase set determination is based, are provided herein.

Assuming a WPR is in relatively close proximity to a WPT (e.g., within a distance of half the wavelength of a channel used for beacon signals or for power transmissions), each of the beacons may have a slightly different performance metrics. For example, there may be slight differences in performance due to the beam characteristics or paths of the beacons: as beams may be focused in wavelength tightness, in distances relative to the size of the WPT, both the width of the beam and the directionality of the beam can be varied, and channel conditions within each path may vary accordingly. Each subantenna at the WPR may have a reciprocal power link to all antenna elements of the WPT, and for optimal power delivery it may be advantageous to select a certain beam or path, based on observations of the beacon signals associated with the signatures to send power towards one of the antennas. Alternatively, or additionally, it may be advantageous to target multiple paths or beams by using a combination of settings, which may deliver better power performance by sending power to multiple antennas.

A decision to select one of the beams or paths to send power towards a single subantenna, or to select multiple paths to send power towards multiple subantennas may be based on observed characteristics of the beacon signals transmitted from the subantennas. In some examples, a WPT may select the beacon or set of beacons having a “best” or “highest” beacon signal quality.

In determining the paths upon which phase settings should be determined for power transmission, the WPT may disregard certain links having beacon signal qualities below a threshold. Such a threshold may be an absolute threshold or a threshold relative to signal qualities of other beacon signals. In some examples, a WPT that knows its gain settings may deduce a noise level from observed I&Q values. If an I&Q set derived from a received beacon signal falls below the noise level, the WPT may choose to disregard the corresponding I&Q sets in the determination of phase settings for power transmission. Alternatively, or additionally, the WPT may apply a weighting coefficient to some or all of the observed phase values, substantially as described above.

In some examples, a WPT that observes a significant drop in quality of one or more beacon signals, relative to a quality of other beacon signals, the WPT may choose to disregard the corresponding I&Q set in the determination of phase settings for power transmission. For instance, if a signal quality or signal strength measurement of a beacon signal (such as an RSSI or a power level expressed in dBM) falls a certain amount below a next lowest signal quality measurement of another beacon signal, or a certain amount below an average signal quality measurement, the WPT may choose disregard the I&Q values of the corresponding path in the determination of phase settings for power transmission. Alternatively, or additionally, the WPT may apply a weighting coefficient to some or all of the observed phase values, substantially as described above.

In some examples, obstructions or interference in the paths between some or all of the antennas of the WPR and the WPT may result in sub-optimal beacon signal quality and power delivery. An example of such a case may be envisioned when the WPR is implemented in a handheld device and a user's fingers physically cause a blockage in the line-of-sight. Another example may be envisioned in the case where either or both of the WPR or the WPT are implemented in a mobile power delivery system and a location or orientation of the WPR and/or the WPT shifts.

In a specific example, a WPR implemented in a device having a substantially planar or multi-planar form factor (such as a cell phone, tablet, or laptop) may be configured with antenna arrays on both sides of a planar surface. The WPR and WPT may be performing beacon signal transmission and power delivery using a subset of the antennas that are located on a face of the planar surface that is opposite an antenna array of the WPT. When the WPR or the WPT experience a change in orientation, the subantennas previously used for beacon signal transmission and/or power delivery may no longer provide the most optimal path or paths between the WPR and the WPT. In such cases, it may be determined that an obstruction is present, and the WPT may need to take measures to optimize its phase settings and transmit power level.

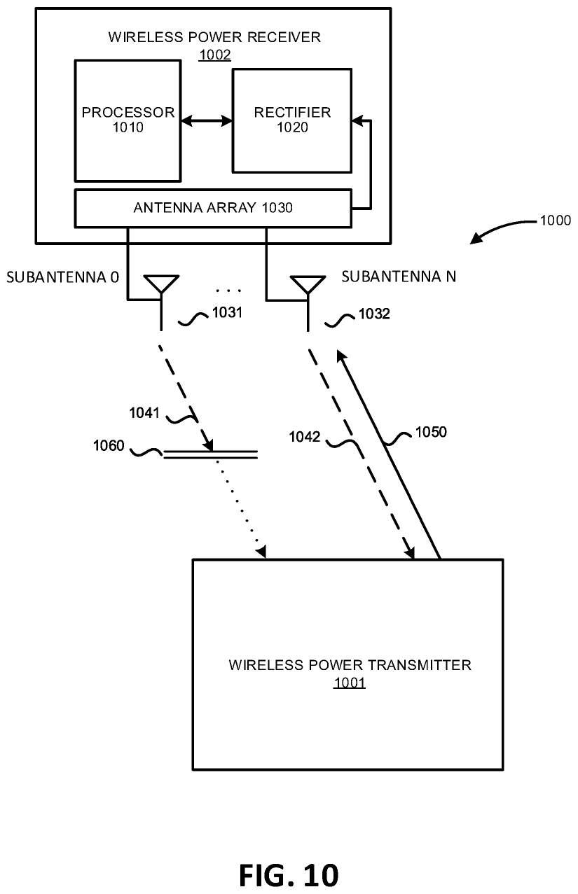

FIG. 10 is a diagram illustrating an example scenario in which a WPT may determine to perform wireless power transmission towards a single subantenna or a subset of subantennas based on the presence of an obstruction in a path between one or more antennas of a WPR and the WPT. As shown in FIG. 10, in a first beacon duration, the WPR 1002 transmits a first beacon signal 1041 toward the WPT 1001 using a first antenna 1031. The beacon signal 1041 may suffer from degraded signal quality due to an obstruction 1060 or interference along the path between the subantenna 1031 and the WPT 1001. As a result, the WPT 1001 either: may not receive the beacon signal 1041 and may not obtain a signature and phase set associated with the subantenna 1031; or, the WPT 1001 may receive the beacon signal 1041, albeit with a lower signal quality or a lower signal strength, and obtain a signature and phase set associated with the subantenna 1031. If the WPT does receive the beacon signal 1041, the WPT may store phase set data, which may be earmarked based on a obtained signature of the subantenna 1031 (e.g., device 0, antenna sub-channel 0). The stored data may include, for example, an I&Q set derived from the received beacon signal. The WPT 1001 may infer the presence of the obstruction 1060 based on at least one of the I&Q set, the signal strength or signal quality associated with the beacon signal 1041. Alternatively, or additionally, the WPT 1001 may infer the presence of the obstruction 1060 when the WPT 1001 expects to receive the beacon signal 1041 but does not.

Following the end of the beacon duration, if the WPT has not received the beacon signal 1041, the WPT may determine not to send a power transmission towards the WPR 1002, having inferred the presence of the obstruction 1060. Even if the WPT does receive the beacon signal 1041, the WPT 1001 may disregard the stored phase set data associated with the beacon signal 1041 given the WPT may have inferred the presence of the obstruction 1060.

The WPR 1002 continues transmitting beacon signals one-by-one using each subantenna. For instance, during a second beacon duration, the WPR 1002 transmits a second beacon signal 1042 toward the WPT 501 using a second subantenna 1032. The second beacon signal 1042 may have a signature different from the signature of the first beacon signal 1041. The WPT 1001 receives the beacon signal 1042 and obtains a signature and phase set associated with the subantenna 1032. The WPT may store the phase set data and earmark the data in association with the obtained signature of the subantenna 1032 (e.g., tagged as device 0, antenna channel 1).

The WPT 1001 sends a wireless power transmission 1050 toward the WPR 1002 using a phase setting that is based on the phase set data earmarked in association with the subantenna 1032 and the beacon signal 1042, not considering phase sets (i.e., I&Q sets) that may be associated with the subantenna 1031 and the beacon signal 1041.

Although FIG. 10 is described above in the context of embodiments where beacon signals for multiple antennas are sent in different beacon durations, the concepts may also be applied in embodiments where beacon signals for multiple antennas are multiplexed in a single beacon duration. In such cases, the WPT, either having not received an expected beacon signal, or having received a beacon signal with a low signal quality, may infer the presence of an obstruction along a path to the corresponding subantenna. For example, the WPT may disregard such path and/or derived I&Q values, or may apply a lower weight to such I&Q values when combined with other I&Q values in vector space to derive the phase settings for wireless power transmissions.

A WPT may be configured with, or may determine, an overall power budget or headroom (e.g., a maximum transmit power) per time slot. In addition, each path between a WPT and a suubantenna of the WPR may have an associated power budget (which may be referred to interchangeably as a link budget). In some examples, a WPT may adjust a power level of a power transmission in order to deliver a greater amount of RF energy to the WPR. In some examples, a WPT may adjust a power budget for one or more links, considering the overall power budget or headroom, in order to optimize power delivery. The WPT may account for such power budget adjustments when determining phase settings for a wireless power transmission. For instance, when combining phase sets in vector space to determine a phase for the power transmission the WPT may apply a higher weight to I&Q values corresponding to higher quality links to increase the amount of power delivered over those links. The WPT may apply a lower weight to I&Q values associated with lower quality links to decrease the amount of power delivered over those links.

In some examples, if a path between the WPT and one subantenna of the WPR suffers from low link quality, while another path between the WPT and another antenna of the WPR has a greater link quality, the WPT may decrease the power budget for the path having low link quality, while increasing the power budget for the path having greater link quality.

As latency and fading may be of less concern in the context of wireless power transmission than in the context of wireless data communication, in some examples, a WPT may determine to not send power transmissions to the WPR in one or more transmission opportunities. For instance, if channel conditions are sub-optimal, e.g., due to a blockage along one or more paths between the WPT and antennas of the WPR, the WPT may determine that the WPT is unable to deliver any meaningful power to the WPR. For instance, the WPT may determine that, in order to deliver sufficient RF power wirelessly, the WPT would need to increase a power budget for the wireless power transmission to an unacceptable, or sub-optimal, level. Such a decision may be made both in cases where a WPR uses only one antenna channel, and in cases where a WPR uses multiple antenna channels.

In some examples, a WPT may perform periodic sampling of beacon signal quality (e.g., every 20 seconds, every 10 minutes, etc.). If a majority of the periodic beacon signal quality samples are acceptable, and subsequently at least a portion of the paths experience a decrease in beacon signal quality, the WPT may determine, e.g., that the affected paths are sub-optimal, or that a blockage has occurred within the affected paths, the WPT may determine to not send power transmissions to the WPR in at least the next transmission opportunity.

A WPR may be configured to determine an efficiency of one or more rectifiers providing DC power from RF power received in a wireless power transmission. The WPR may be configured to measure the received power strength (e.g., consistent with embodiments illustrated and described above with reference to FIG. 3) along each antenna's power path or along a path carrying combined power from two or more antennas. The WPR may also be aware of the RF power levels of wireless power transmissions received at each of the antennas, and may be configured to determine its efficiency in providing DC power from the RF power at each antenna.

The WPR may be configured to adjust parameters to maximize such efficiency. For example, if the WPR observes a low rectification efficiency along a power path of an antenna, the WPR may direct the WPT to cease sending wireless power transmissions towards the antenna and/or may direct the WTPS to route wireless power towards other antennas for which rectification efficiency is higher. In some cases, the WPR may cease sending beacon signals on the subantenna associated with the less efficient power path such that the WPT does not derive I&Q values for that antenna channel and does not account for the path in the determination of phase settings for wireless power transmission. In some cases, the WPR may be configured to feedback efficiency information to the WPT, such as in data sent over a communications link or in a preamble included in one or more beacon signals. The WPT may account for such efficiency levels in the determination of phase settings or power budgets for wireless power transmissions.

Embodiments as described herein may conceivably be implemented in wireless systems and environments operating in any band, such 2.4 GHZ, 5.8 GHZ, up to 24 GHZ, 60 GHZ, and beyond. The advantages of methods and procedures described herein may be most evidently realized in systems operating in higher frequencies, where beams may be narrow relative to receiver antennas and their encompassing arrays. For example, a device operating in a 60 GHz band, having an antenna array with an aperture measuring 5 centimeters (cm) by 5 cm may have hundreds of antennas. In such a case, beam optimization according to embodiments provided herein may offer finer adjustment of spatial coverage and orientation of the beams of power transmissions and may lead to performance gains in wireless power delivery and harvesting.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a WPT or WPR.

What is claimed is:

1. A wireless power receiver (WPR) comprising:
a processor;
an antenna array comprising a plurality of subantennas; and
a rectifier;
wherein the processor and the antenna array comprising the plurality of subantennas are configured to transmit, in a plurality of beacon durations, a respective plurality of beacon signals, wherein each of the respective plurality of beacon signals is associated with a respective phase set;
wherein at least one of the plurality of subantennas receives, following each of the beacon durations, a wireless power transmission transmitted by a wireless power transmitter (WPT), the wireless power transmission using phase settings based on at least one phase set derived from at least one beacon transmitted in previous beacon durations; and
wherein the rectifier is configured to provide direct current (DC) voltage from radio frequency (RF) energy received in the wireless power transmission.

2. The WPR of claim 1, wherein each of the beacon signals carries a signature associated with a respective one of the plurality of subantennas.

3. The WPR of claim 1, wherein the phase settings of the wireless power transmissions are based on a combination of phase sets derived from a plurality of beacons transmitted in previous beacon durations.

4. The WPR of claim 1, wherein the at least one beacon from which the at least one phase set is derived is transmitted from the at least one of the plurality of subantennas that receives the wireless power transmission.

5. The WPR of claim 1, wherein another at least one of the plurality of subantennas does not receive the wireless power transmission from the WPT, based on a signal quality of a beacon signal transmitted using the another at least one of the plurality of subantennas.

6. The WPR of claim 1, wherein at least one of the plurality of antennas receives the wireless power transmission from the WPT at a power level lower than another subantenna, based on a signal quality of a beacon signal transmitted using the at least one of the plurality of subantennas.

7. The WPR of claim 1, wherein the phase settings of the wireless power transmission are further based on an efficiency of the rectifier in providing DC voltage.

8. A wireless power receiver (WPR) comprising:
a processor;
an antenna array comprising a plurality of subantennas; and
a rectifier;
wherein the processor and the antenna array comprising the plurality of subantennas are configured to transmit a respective plurality of beacon signals in a beacon duration, wherein each of the respective plurality of beacon signals is associated with a respective phase set;
wherein at least one of the plurality of subantennas receives, following the beacon duration, a wireless power transmission transmitted by a wireless power transmitter (WPT), the wireless power transmission using phase settings based on at least one phase set derived from at least one beacon transmitted in the beacon duration; and
wherein the rectifier is configured to provide direct current (DC) voltage from radio frequency (RF) energy received in the wireless power transmission.

9. The WPR of claim 8, wherein the processor and at least one of the plurality of subantennas is configured to transmit information indicating: a number of beacons to be transmitted, a number of the plurality of subantennas, a multiplexing scheme to be applied to the beacon signals, a time interval length, or a sequence of the beacon signals to be transmitted.

10. The WPR of claim 8, wherein the information is transmitted in a preamble, and wherein the preamble is transmitted at the beginning of at least one of the plurality of beacon signals.

11. The WPR of claim 8, wherein the plurality of beacon signals are time-division multiplexed.

12. The WPR of claim 8, wherein the plurality of beacon signals are code-division multiplexed.

13. The WPR of claim 8, wherein the phase settings of the wireless power transmissions are based on a combination of phase sets derived from at least a subset of the plurality of beacons transmitted in the beacon duration.

14. The WPR of claim 8, wherein the phase settings of the wireless power transmission are further based on an efficiency of the rectifier in providing DC voltage.

15. A method performed by a wireless power receiver (WPR) comprising:
transmitting, using a plurality of subantennas of an antenna array, a respective plurality of beacon signals in a beacon duration, wherein each of the respective plurality of beacon signals is associated with a respective phase set;
receiving, by at least one of the plurality of subantennas, following the beacon duration, a wireless power transmission transmitted by a wireless power transmitter (WPT), the wireless power transmission using phase settings based on at least one phase set derived from at least one beacon transmitted in the beacon duration; and
providing direct current (DC) voltage from radio frequency (RF) energy received in the wireless power transmission.

16. The method of claim 15, further comprising transmitting, by at least one of the plurality of subantennas, information indicating: a number of beacons to be transmitted, a number of the plurality of subantennas, a multiplexing scheme to be applied to the beacon signals, a time interval length, or a sequence of the beacon signals to be transmitted.

17. The method of claim 16, wherein the information is transmitted in a preamble, and wherein the preamble is included at the beginning of at least one of the plurality of beacon signals.

18. The method of claim 15, wherein the plurality of beacon signals are time-division multiplexed.

19. The method of claim 15, wherein the plurality of beacon signals are code-division multiplexed.

20. The method of claim 15, wherein the phase settings of the wireless power transmissions are based on a combination of phase sets derived from at least a subset of the plurality of beacons transmitted in the beacon duration.
